(19) United States
(12) Patent Application Publication
(10) Pub. No.: US 2015/0110248 A1
(43) Pub. Date: Apr. 23, 2015

(54) RADIATION DETECTION AND METHOD FOR NON-DESTRUCTIVE MODIFICATION OF SIGNALS

(71) Applicant: YARON RABI, Zur Moshe (IL)

(72) Inventor: YARON RABI, Zur Moshe (IL)

(21) Appl. No.: 14/520,640

(22) Filed: Oct. 22, 2014

Related U.S. Application Data
(60) Provisional application No. 61/893,915, filed on Oct. 22, 2013.

(51) Int. Cl. G01T 1/20; G01T 1/208

(52) U.S. Cl. CPC G01T 1/2018; G01T 1/208
USPC 378/62

(57) ABSTRACT

A radiation detector, comprising: a scintillator layer; an array of active pixel sensors (APS); at least one internal temperature sensor coupled to at least one pixel; at least two feedback circuits embedded into each pixel; processing electronics configured to allow sampling of said electrical signals by the at least two feedback circuits, and configured to allow corrections corresponding to the measured temperature such that a clean image is produced; and an internal memory unit coupled to the array of APS, and configured to allow storage of correction parameters and of at least two images corresponding to the array of pixels, wherein the radiation detector is configured to acquire at least two images, corresponding to the at least two feedback circuits, and wherein the radiation detector outputs a single, merged image.

### CROSS-REFERENCE TO RELATED APPLICATION

The present application is based upon and claims priority from U.S. Provisional Patent Application S. N. 61/893,915 filed Oct. 22, 2013, and entitled “Radiation Detector and Method for Modification of Signals”.

### FIELD OF THE INVENTION

The present invention relates to detection of radiation. More particularly, the present invention relates to an apparatus and a method for modification of signals originating from radiation detectors.

### BACKGROUND OF THE INVENTION

Typical radiation detectors are based upon an array of pixels. Each of these pixels consists of a sensitive area, intended for converting the radiation energy into an electrical signal, and also of adjacent electronics for further processing (e.g. amplifying and digitizing) the electrical signal.

The dynamic range of the detector is defined as the ratio between the maximal and the minimal detectable radiation quotients. The challenge of increasing the dynamic range has been troubling the industry for several decades, with the goal of reducing the detectors' noise level (thus decreasing the size of the minimal detectable quotient) and increasing the “well” size (increasing the maximal detectable quotient). Typical techniques use “multiple reading” of the accumulated electric signal, where the signal is processed by multiple electronic circuits, with multiple electronic characteristics, and only one output value is spooled further, which best fits the measured signal.

Furthermore, when acquiring a raw image with a radiation detector, several essential manipulations (i.e. offset, gain and defect corrections) are required for each pixel in order to generate a clear image (correcting the sensor/scintillator non-uniformities). Those manipulations can be referred to as a pre-processing procedure, with an additional post-processing procedure performed on the corrected image once the pre-processing procedure is completed.

U.S. Pat. No. 8,115,824 describes an active pixel sensor (APS) for reading out a pixel signal depending on an amount of light irradiated during a predetermined integration time and resetting the optical pixel upon termination of the predetermined integration time. The pixel signals are processed and the modified signals are provided as the output.

U.S. Pat. No. 7,498,585 describes a charged particle detector and a method providing simultaneous detection and measurement of charged particles at one or more levels of particle flux in a single measurement cycle. The detector provides multiple and independently selectable levels of integration and/or gain in a fully addressable readout manner.

U.S. Pat. No. 7,791,032 describes digital imaging architectures including detectors coupled to a readout circuitry, wherein the readout circuitry functions in particular modes, the use of which can depend on characteristics of the input signals transferred to the readout circuitry from the detectors, or can depend on the characteristics of the output signal required from the readout circuitry.

However, all of the devices described in the cited art regard each pixel separately, adapting the reading circuitry to the pixel signal only. Therefore, a need arises for a device that allows flexible image reading using whole-image information, thereby allowing a feature-conformal merging of the two images.

### SUMMARY OF THE INVENTION

It is therefore provided in accordance with an embodiment of the present invention, a detector for detecting radiation that comprises:

a scintillator layer configured to allow conversion of the radiation into optical signals;

an array of active pixel sensors (APS) positioned adjacent to the scintillator layer such that the optical signals are detected by the array of APS, and configured to allow conversion of the optical signals into electrical signals;

at least one internal temperature sensor coupled to at least one pixel of the array of APS, the at least one internal temperature sensor providing measurement of temperature;

at least two feedback circuits embedded into each pixel of the array;

processing electronics configured to allow sampling of said electrical signals by the at least two feedback circuits, and configured to allow corrections corresponding to the measured temperature such that a clean image is produced; and

an internal memory unit coupled to the array of APS, and configured to allow storage of correction parameters and of at least two images corresponding to the array of pixels,

wherein the radiation detector is configured to acquire at least two images, corresponding to the at least two feedback circuits, and wherein the radiation detector outputs a single, merged image.

Furthermore, in accordance with another embodiment, the at least two feedback circuits comprise:

a high-sensitivity reading circuit;
a low-sensitivity reading circuit, and

at least one switch configured to allow direction of electrical signals to at least one of the feedback circuit.

Furthermore, in accordance with another embodiment, the at least one internal temperature sensor is movable such that a dynamic temperature scan is carried out.

It is furthermore provided in accordance with yet another embodiment, a method for non-destructive radiation detection of an external object, the method comprising:

providing a scintillator layer configured to allow conversion of radiation into optical signals;

providing an array of active pixel sensors (APS) positioned adjacent to the scintillator layer, and configured to allow conversion of the optical signals into electrical signals;

providing at least two feedback circuits embedded into each pixel;

providing processing electronics coupled to each pixel;

performing a measurement of the object with external radiation;

sampling of the electrical signals from the array of APS with the processing electronics, for each of the at least two feedback circuits;

creating a full image corresponding to data from the pixels for each of the at least two feedback circuits;

performing a merger algorithm capable of combining data from the full images into a single image; and

outputting the single image.

Furthermore, in accordance with another embodiment, the method further comprising:

providing an internal memory unit coupled to the APS array;

performing an air measurement, while no object is detected;

storing air parameters in the internal memory unit;

performing a dark current measurement, while no external radiation is detected;

storing dark current parameters in the internal memory unit;

calculating offset and gain values for each pixel of the array of APS, based on the stored dark current parameters and on the air parameters;

storing the offset and gain values in the internal memory unit; and

correcting data from each pixel of the array of APS according to the offset and gain values, wherein the correction of the pixels produces a clean image.

Furthermore, in accordance with another embodiment, the method further comprises storing the full images corresponding to the pixels of the array of APS in the internal memory unit.

Furthermore, in accordance with another embodiment, the method further comprising:

selecting a group of pixels of the array of APS having a common feature from at least one of the full images corresponding to the at least two feedback circuits; and

introducing the selected group of pixels into the merged image.

Furthermore, in accordance with another embodiment, the method further comprising:

providing a high-sensitivity reading circuit;
providing a low-sensitivity reading circuit;
providing at least one switch configured to allow direction of electrical signals to at least one of the feedback circuit;
reading high-sensitivity data with the high-sensitivity reading circuit;
storing the high-sensitivity data in a first database;
reading low-sensitivity data with the low-sensitivity reading circuit; and
storing the low-sensitivity data in a second database.

Furthermore, in accordance with another embodiment, the method further comprising:

providing at least one internal temperature sensor coupled to at least one pixel of the array of APS;

providing an internal memory unit coupled to the APS array;

performing an air measurement, while no object is detected;

storing air parameters in the internal memory unit;

performing a dark current measurement, while no external radiation is detected;

storing dark current parameters in the internal memory unit;

calculating offset and gain values for each pixel of the array of APS, based on the stored dark current parameters on the air parameters, on the measured temperature and on the acquisition time; and

correcting scan data from each pixel according to the offset and gain values,

wherein the correction of the pixels produces a clean image.

In addition, there is provided in accordance with yet another embodiment, a method for non-destructive radiation detection of an external object, the method comprising:

providing a scintillator layer configured to allow conversion of radiation into optical signals;

providing an array of active pixel sensors (APS) positioned adjacent to the scintillator layer, and configured to allow conversion of the optical signals into electrical signals;

providing at least one internal temperature sensor coupled to at least one pixel of the array of APS;

providing an internal memory unit coupled to the APS array;

providing processing electronics coupled to each pixel;

performing an air measurement, while no object is detected;

storing air parameters in the internal memory unit;

performing a dark current measurement, while no external radiation is detected;

storing dark current parameters in the internal memory unit;

performing a measurement of the external object with external radiation;

sampling of the electrical signals from the APS with the processing electronics;

calculating offset and gain values for each pixel of the array of APS, based on the stored dark current parameters, on the stored air parameters, on the measured temperature and on the acquisition time;

correcting data from each pixel according to the calculated offset and gain values;

creating a full image corresponding to the corrected data from the pixels of the array of APS; and

outputting the corrected full image.

Furthermore, in accordance with another embodiment, the method further comprises storing the full image corresponding to the pixels of the array of APS, in the internal memory unit.

Furthermore, in accordance with another embodiment, the method further comprising:

providing at least two feedback circuits embedded into each pixel;

creating a full image corresponding to data from the pixels of the array of APS for each of the at least two feedback circuits; performing a merger algorithm capable of combining data from the full images into a single image; and

outputting the corrected single image.

Furthermore, in accordance with another embodiment, the method further comprising: providing at least two feedback circuits embedded into each pixel;

creating a full image corresponding to data from the pixels of the array of APS for each of the at least two feedback circuits;

performing a merger algorithm capable of combining data from the full images into a single image;

selecting a group of pixels of the array of APS having a common feature from at least one of the full images corresponding to the at least two feedback circuits;

introducing the selected group of pixels into the single image; and

outputting the corrected single image.

Furthermore, in accordance with another embodiment, the method further comprising:

providing at least two feedback circuits embedded into each pixel, wherein at least one feedback circuit comprises a high-sensitivity reading circuit and at least one feedback circuit comprises a low-sensitivity reading circuit;

providing at least one switch configured to allow direction of electrical signals to at least one of the feedback circuit;

reading high-sensitivity data with the high-sensitivity reading circuit;
storing the high-sensitivity data in a first database;
reading low-sensitivity data with the low-sensitivity reading circuit;
storing the low-sensitivity data in a second database;

performing a merger algorithm capable of combining data from the full images into a single image; and

outputting the corrected single image,

wherein a full image is created for the high-sensitivity reading circuit and for the low-sensitivity reading circuit.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the specification, including definitions, will control. In addition, the materials, methods, and examples are illustrative only and not intended to be limiting.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding of the invention, the description taken with the drawings making apparent to those skilled in the art how the several forms of the invention may be embodied in practice.

In the drawings:

FIG. 1 schematically illustrates a commercially available flat panel detector (FPD).

FIG. 2 schematically illustrates an improved radiation detection apparatus with an active pixel sensor array, according to an exemplary embodiment.

FIG. 3 shows a scheme of the pixel and of the readout electronics for the improved radiation detection apparatus, according to an exemplary embodiment.

FIG. 4 shows a typical image taken from a FPD at dark conditions, according to an exemplary embodiment.

FIG. 5A shows typical values of the base line offset component at different temperatures for an exemplary FPD, according to an exemplary embodiment.

FIG. 5B shows typical values of the dark current offset component at different temperatures for an exemplary FPD.

FIG. 6A shows a first cold start experiment for an exemplary FPD, according to an exemplary embodiment.

FIG. 6B shows a second cold start experiment for an exemplary FPD.

FIG. 7A shows a soft tissue low sensitivity image, according to an exemplary embodiment.

FIG. 7B shows a soft tissue high sensitivity image, according to an exemplary embodiment.

FIG. 7C shows a soft tissue merged image, according to an exemplary embodiment.

FIG. 8A shows a metal low sensitivity image, according to an exemplary embodiment.

FIG. 8B shows a metal high sensitivity image, according to an exemplary embodiment.

FIG. 8C shows a metal merged image, according to an exemplary embodiment.

### DESCRIPTION OF THE PREFERRED EMBODIMENTS

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For clarity, non-essential elements were omitted from some of the drawings.

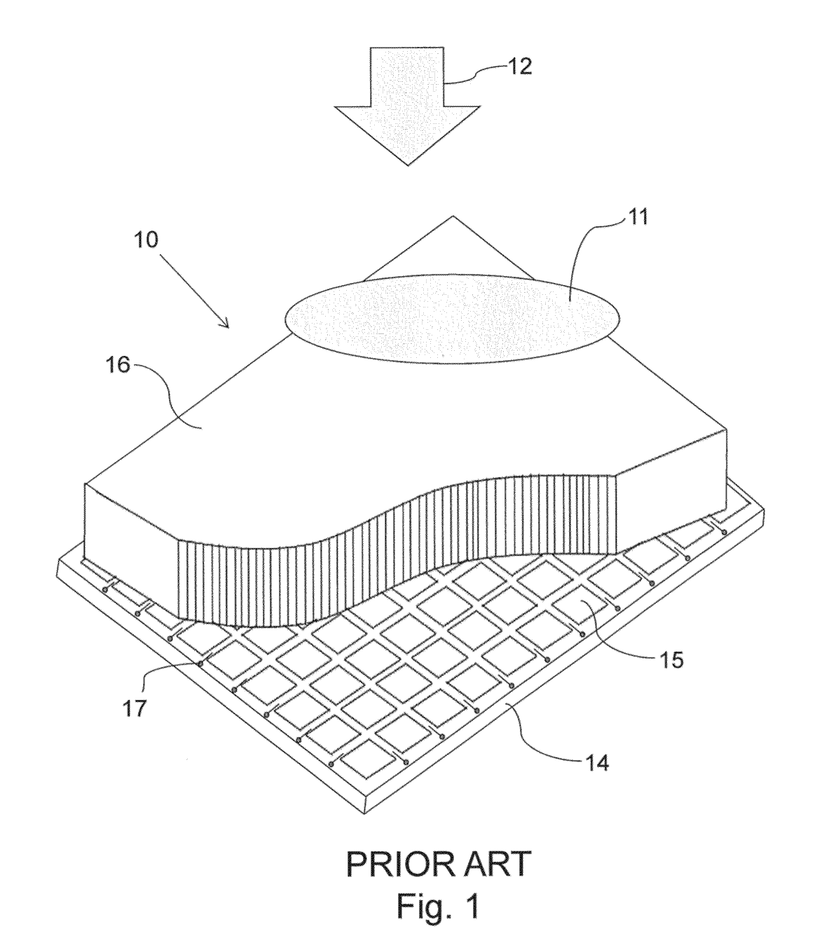

FIG. 1 schematically illustrates a commercially available flat panel detector (FPD) 10. X-rays from a source 12 are passing through, scattered by, or passing by a subject 11 and striking a scintillator layer 16, where the X-rays are converted into visible light arriving at the pixel array 14. Similarly to a digital camera's image sensor chip, each pixel 15 also contains a photodiode generating an electrical signal in proportion to the light produced by the portion of scintillator layer 16 in front of the pixel 15. The signals from pixels 15 are amplified and encoded by additional electronics 17 positioned at the edges of the pixel array 14 in order to produce an accurate and sensitive digital representation of the X-ray image. Due to the impracticability of focusing X-rays, the sensors of the FPD 10 have the same size as the image they capture.

Typical scintillators 16 have an inherent conversion factor, such that the number of visible photons per pixel per one X-ray photon in the range 200-4000. The number of X-ray photons depends on the radiated dose which can vary between a few nGray per frame in a first mode (“Fluoro”) to μGray and more for a second mode (“Radio”). This order of magnitude in the dose implies orders of magnitude change for the collection charge capacity in the pixels 15. It will therefore be advantageous to utilize pixel reading electronics in order to allow continuous reading for both of these modes.

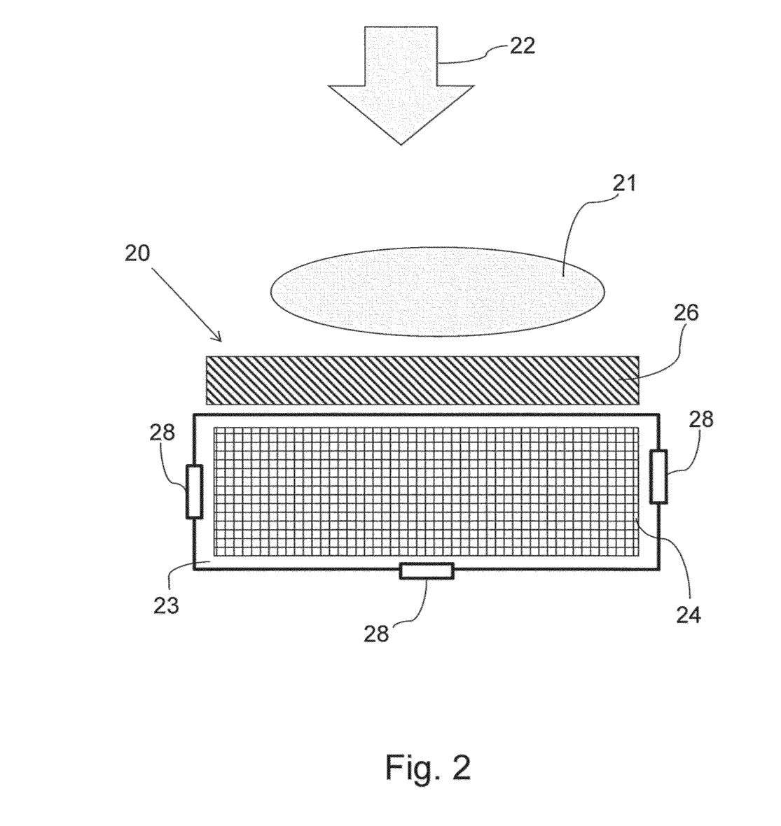

FIG. 2 schematically illustrates an improved radiation detection apparatus 20, comprising an array of active pixel sensors (APSs) 24. Object 21 is irradiated with radiation from source 22, with some of the rays arriving at a scintillator layer 26 and from there signals corresponding to the received radiation are transmitted to the APS 24. Each active pixel sensor 24 allows reading multiple electrical characteristics of a signal (further described hereinafter). Thus resulting in a plurality of output frames, with non-destructive reading of each pixel (i.e. reading and manipulating the signal practically without changing it) by using high-impedance voltage sensing with a set of customized reading circuits at the each of the APS pixels.

Additionally, internal temperature sensors 28 may be placed on the APS board 23 for continuous temperature reading. This radiation detection apparatus 20 may also be used in dynamic reading mode, where a continuous scanning of an object (for instance a panoramic dental reading) takes place with ongoing correction of the dynamic reading. Optionally, the radiation detection system further comprises means for preforming panoramic scans.

In an additional embodiment, the temperature sensors may be embedded into the APS board as dedicated pixels for temperature sensing, and not as a separate element.

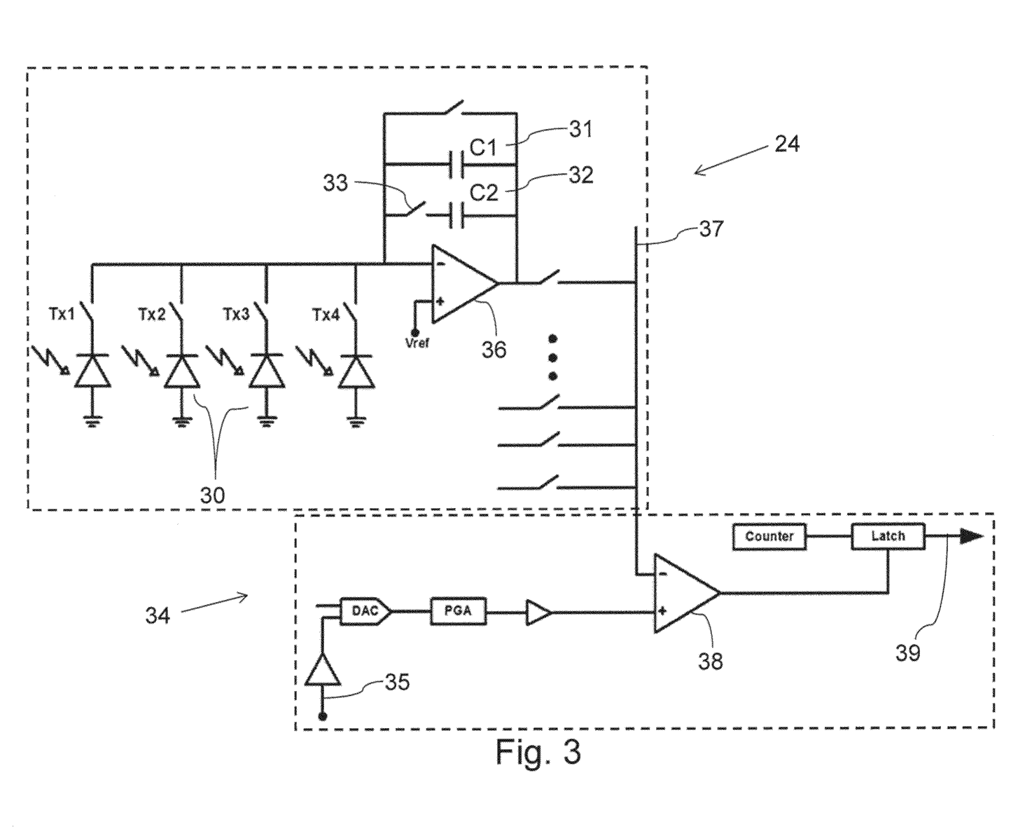

FIG. 3 shows a scheme of the pixel 24 and of the readout electronics 34 for the improved radiation detection apparatus 20 (as shown in FIG. 2). Using analog binning of several photodiodes 30, the accumulated charge in the sensor may be amplified with a preamplifier 36 and switched 33 between two feedback modes: a first mode (“Fluoro”) and a second mode (“Radio”). The first mode 31 has a high-sensitivity reading circuit with a first feedback capacitor C1, and the second mode 32 has a low-sensitivity reading circuit with both feedback capacitors C1+C2 as dual-gain architecture. The voltage of several pixels 24 may be transferred down a pixel column line 37 to a comparator 38 that compares the received data to a reference voltage 35 (going through additional amplification and filtering to reduce noise), until the data is provided as output 39. It should be noted that a pixel with a large signal may activate the low-sensitivity circuit 32 in order to avoid saturation.

In this way, when a signal is detected by the pixel array 24, the feedback loops 31, 32 may allow multiple non-destructive readings for the same signal as both feedback circuits are sampled without altering the output voltage. Namely, an image may be measured once with the high-sensitivity reading circuit 31 and once with the low-sensitivity reading circuit 32 (due to the switching 33) so that these readings do not disrupt each other. Such non-destructive readings cannot be performed with current methods.

In a further embodiment, an internal memory unit is embedded in the APS board and configured to allow storage of calibration correction parameters (further described hereinafter). The internal memory unit may also store two full (corrected) images corresponding to the pixels, wherein combined data from all pixels is stored as a full image in the internal memory unit.

In a typical configuration, the high-sensitivity capacitor C1 is ˜70 fF, the low-sensitivity capacitor C2 is ˜500 fF, the capacitance of a photodiode 30 is ˜1 pF, and the reference voltage 35 is ˜1V.

### Offset Calibration

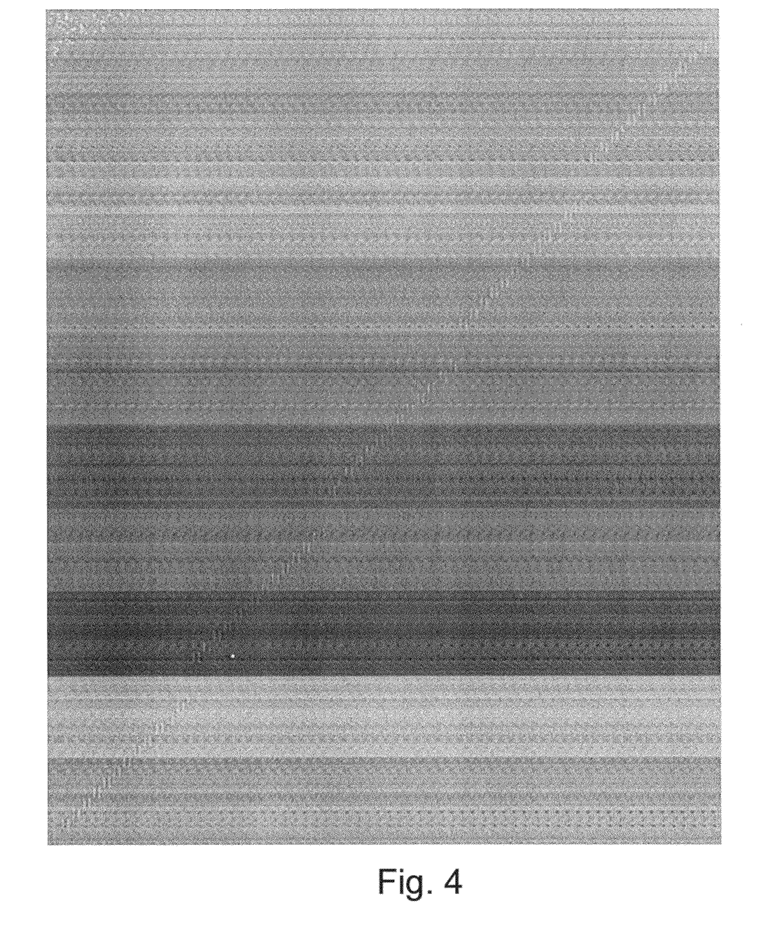

FIG. 4 shows a typical image taken from a FPD in dark conditions. It is clearly seen from FIG. 4 that each pixel has its own offset level, which needs to be subtracted. The offset of each pixel in an image is influenced by the frame rate, the temperature and the gain settings. Therefore, before acquiring X-ray images by a flat panel detector (FPD), a flat dark image must be acquired in order to compensate for the unequal offset levels. The offset level may be measured prior to each measurement session, by acquiring the signal without X-ray radiation (i.e. a dark signal). Such offset data is accurate in static exposures, where the offset scan and the actual clinical scan are sequential, thus are close in time. However, in long dynamic fluoroscopic scans where the temperature changes notably during the course of the measurement, a method and device for analytically calculating the offset is required.

Such devices and methods for analytically calculating the offset of an entire image have the following advantages over a standard offset correction method and device:
Continuous acquisition during mode change—eliminates the need to calibrate the offset table after changing the offset mode (changing the frame rate or the region of interest) at a given gain setting, i.e. the frame rate could be varied “on the fly”.
Resilience to temperature changes—the offset image is resilient to temperature changes as long as the temperature is regularly sampled. The algorithm may thus compensate for offset changes due to temperature variations during a “cold” start or during long x-ray procedures.
Less calibration tables and eliminations of the “offset modes”—with a given specific gain setting, each different frame rate setting or different region of interest (ROI) setting has its own offset table, with the algorithm requiring only a small number of independent parameters for each pixel (typically 2-4), regardless of the number of “offset modes”, i.e. four calibration tables are maintained regardless of the number of the “offset modes”.
Prevention of dose saturation by adjustable integration time with closed loop control of the signal by real time adjustment of the integration time, thereby compensating for poor penetration depth (for thick bodies).
Calibration values available even for continuously variable acquisition times—This feature is useful when performing panoramic scans with variable acquisition times (e.g. for dental procedures).

With the advantage of compensating for the offset change due to temperature variations, it is possible to seamlessly merge full images so that a composite image may be constructed according to various criteria (e.g. minimal noise, noise distribution). This correction is particularly important for long dynamic fluoroscopic scans, where the temperature drifts continuously during the scan.

Each offset from a signal of a pixel has two components:
“Baseline offset”—a frame rate (fps) independent component.
“Dark current”—a component that increases with the integration time and decreases with increased frame rate.
   Both offset components change with temperature, where the offset signal could be separated into its baseline component and its dark current component by measuring the offset image at two frame rates, f1 (for low fps) and f2 (for high fps). The dark current I of pixel (i,j) is given by eq. (1), where t1=1/f1 and t2=1/f2 are the integration times at low and high acquisition frame rates respectively and s1 and s2 are the corresponding offsets at those frame rates.

$$I ( i , j ) = \frac{s 1 ( i , j ) - s 2 ( i , j )}{t 1 - t 2} \qquad ( 1 )$$

The baseline offset level, O, is calculated by subtraction of the dark current component from the offset signal as shown in eq. (2):

O(i,j)=S2(i,j)−t2·I(i,j) (2)

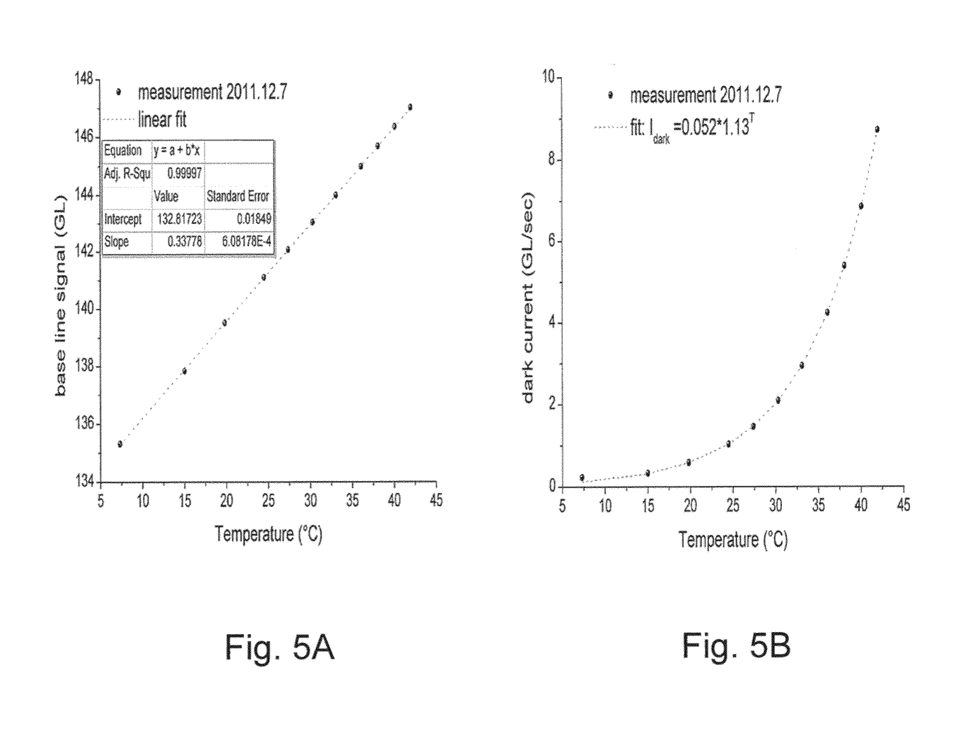

Typically, the baseline offset changes linearly with temperature while the dark current changes exponentially with temperature (as may be seen for example in FIGS. 5A and 5B).

For a universal offset calibration, a standard flat pixel detector (FPD) may be coupled to a chiller/heater and sealed in a Thermocole (e.g. Polystyrene) container, so that the temperature of the FPD may be stabilized at a predefined set-point temperature. At each of N_{T} predefined temperatures, a sequence of 2_{seq} images may be acquired at alternating frame rates—where the first frame is captured following integration time t1 (for low acquisition frame rate), the second frame is captured after integration time t2 (for high acquisition frame rate), third image after integration time of t1 and so on (alternating between low and high acquisition frame rate). At the end of the process N_{seq} images are captured following integration time t1, and N_{seq} images are captured following integration time of t2 at each of the predefined set-point temperatures. The N_{seq} images which were each captured following integration time t1 may be averaged for a predefined set-point temperature Tₛₑₜ, and similarly the other N_{seq} images obtained after integration time t2 may be averaged. The calibration dark current, Ĩ, and the calibration baseline offset, Õ, may be calculated using equations (1) and (2) respectively.

A linear equation, (eq. (3)), for the general pixel baseline offset can be derived from the baseline offsets measured at each temperature (from eq. (2)) by employing a standard trust region reflective algorithm on the measured offsets, and the general pixel analytical dark current, Ĩ, may similarly be modeled by eq. (4) using the same algorithm, where T denotes the measured temperature at each pixel.

Õ(i,j,T)=A(i,j)T+B(i,j) (3)

Ĩ(i,j,T)=C(i,j)·D(i,j)^{T} (4)

Once the calibration is done, four parameters are associated with each pixel—two coefficients of the linear equation from which the baseline offset is calculated and two coefficients of the exponential equation from which the dark current is calculated. For calculating the offset table, first the temperature of the sensor is measured and then the offset is calculated according to eq. (5).

O_{T}(i,j,T)=Õ(i,j,T)+Ĩ(i,j,T)/f (5)

The temperature of the sensor may be measurable by one of the following methods:
Temperature sensors (as seen in FIG. 2), on the printed circuit board (PCB), with the temperature sensor typically limited to 1° C. temperature resolution.
Using dark frame(s) once every predefined period of time or at every temperature change of the PCB's temperature sensor, and using one of the following methods:
   a. Acquiring one dark image (for initial dark conditions, without external light). Calculating the dark current (eq. (4)) using the previous temperature reading (the initial temperature may be taken as the temperature of the PCB temperature sensor). The temperature of the current may be calculated by subtracting the dark current from the acquired image:

$$T = \frac{1}{A} ( \overline{O} - \overline{B} - \overline{I} ) where \{ \begin{matrix}\overline{O} = {\sum }_{i} {\sum }_{j} O ( i , j ) \\ \overline{A} = {\sum }_{i} {\sum }_{j} A ( i , j ) , \overline{B} = {\sum }_{i} {\sum }_{j} B ( i , j ) \\ \overline{I} = {t}_{fps} {\sum }_{i} {\sum }_{j} I ( i , j )\end{matrix} \qquad ( 6 )$$

where t_{fps} is the period of one image (sec) which is associated with the frame rate at which the image was acquired, and the “A” and “B” coefficients may be calculated from eq. (3).
b. Acquiring images at very high frame rates (e.g. 400 fps). Due to the high frame rate the dark current may be negligible, with negligible influence on the offset table, there fore the entire offset may be assumed to be due to the baseline offset. The temperature may be calculated from Eq. 7:

$$T = \frac{1}{A} ( \overline{O} - \overline{B} ) where \{ \begin{matrix}\overline{O} = {\sum }_{i} {\sum }_{j} O ( i , j ) \\ \overline{A} = {\sum }_{i} {\sum }_{j} A ( i , j ) , \\ \overline{B} = {\sum }_{i} {\sum }_{j} B ( i , j )\end{matrix} \qquad ( 7 )$$

The summation iterates over the functional pixels and skips the defect pixels (identified in the pre-processing procedure, mentioned in the background), where the “A” and “B” coefficients may be calculated from eq. (3).
c. Acquiring two dark images, one at low fps and one at high fps. Calculating the dark current according to eq. (2) and comparing to the average analytic dark current:

$$T = log ( \frac{I}{C} ) / log ( D ) where \{ \begin{matrix}\overline{I} = {\sum }_{i} {\sum }_{j} I ( i , j ) \\ \overline{C} = {\sum }_{i} {\sum }_{j} C ( i , j ) \\ \overline{D} = {\sum }_{i} {\sum }_{j} D ( i , j )\end{matrix} \qquad ( 8 )$$

The summation iterates over the functional pixels and skips the defect pixels, where the “C” and “D” coefficients may be calculated from eq. (4).
Acquiring data with temperature sensors incorporated on the printed circuit board 23 as dedicated pixels.

The algorithm may be evaluated in terms of stability overtime and in terms of correcting the offset table in cases where the temperature changes relatively quickly (e.g. cold start scenario, with images taken prior to temperature increase).

### EXAMPLES

FIGS. 5A and 5B show typical values of the offset components at different temperatures for an exemplary FPD. The baseline offset (shown in FIG. 5A) exhibits linear variation with temperature, while the dark current (shown in FIG. 5B) changes exponentially with temperature.

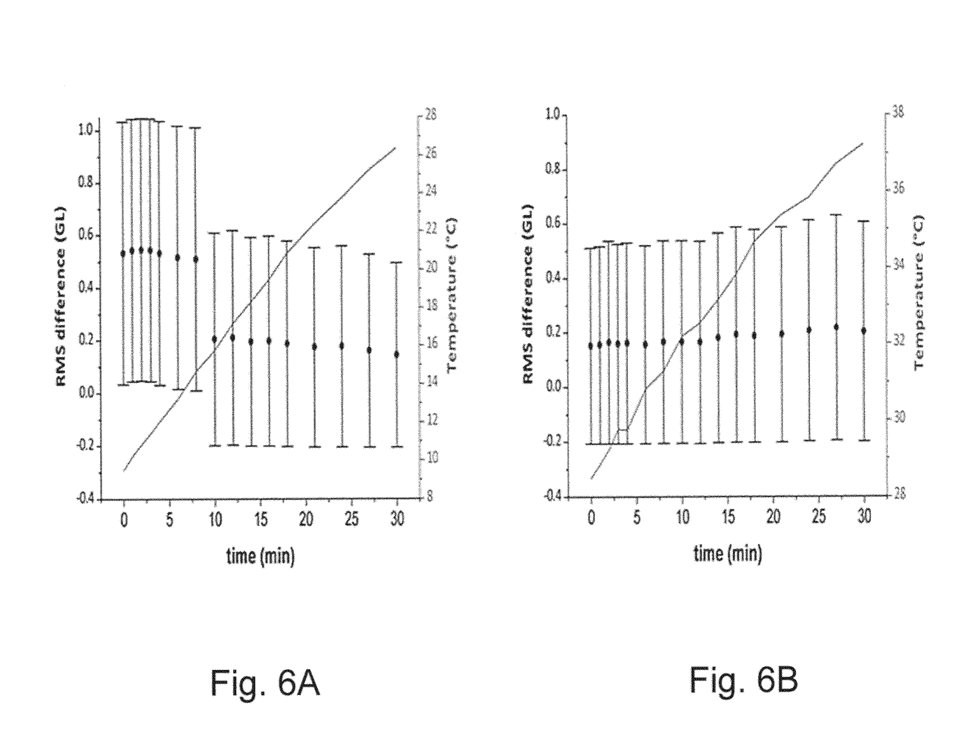

FIGS. 6A and 6B illustrate the ability of the universal offset calibration algorithm to evaluate a valid offset table during a cold start for an exemplary FPD, showing in each figure differences between two cold start experiments. RMS errors in a conventional offset table are shown in FIG. 6A and RMS errors in a universal offset table are shown in FIG. 6B. To obtain these results, first the FPD was unplugged from power for four hours. At each of the predefined time steps after the power up, a sequence of 25 images was acquired using 10 fps settings. An offset table was computed from those 25 images, with another offset table computed using the universal offset algorithm. The calibration parameters were calculated one month before the cold start experiment. An additional solid curve may be seen for the temperature (versus time) which was calculated from the dark frames by the universal offset algorithm. For comparison purposes, a sequence of 50 images was acquired using a frame rate of 10 fps. The FPD temperature was kept at 26° C. using the chiller. Two offset tables were calculated from that sequence with one table from the first 25 images and the second from the last 25 images.

### Gain Calibration

The gain calibration is meant to compensate for the variation in pixel sensitivity. The calibration table is typically prepared once in several months. Typically, a set of flat-field (no object) measurements is performed and the data is stored. Then, offset is subtracted from each data and measurements in the set are averaged to give a single value for each pixel. Typically, the reciprocal of this single value is kept, multiplied by the whole-FPD average. Thus, a matrix of correction values is obtained, stored and used for gain correction.

The gain values are also susceptible to temperature variation, although less than the offset values. Therefore, the same method of automatic correction can be used for the gain table: A set of gain tables can be produced, at various ambient temperatures, for various acquisition times. Then, the temperature dependence can be estimated, which is composed of two parts: time-independent one, which is linear with temperature, and time-dependent one, with exponential temperature dependence.

In real-time, the temperature is measured by specialized sensors and the temperature-dependent gain-correction value is evaluated for each pixel. An optimal gain for each pixel may be chosen so that if the high-sensitivity value is saturated, the system may take the other value. Otherwise, the high sensitivity value may be used.

### Merger Algorithm

The two images, taken with two different feedback loops (“gains”) are stored in the FPD RAM. Possibly, said RAM is a part of the APS board. Alternatively, the RAM is a dedicated chip. Then, the offset, gain and defect corrections are internally performed, resulting in two clean images. In the next step, a merger algorithm synthesizes the two clean images into a single image. Then, the front panel detector (FPD) outputs this single, merged image to the host system.

Alternatively, the FPD also outputs (in offline state), the two raw images. Alternatively yet, the FPD also outputs the two clean images. However, these extra images are typically transferred for debugging purposes, while the merged image is the only one used for clinical purposes. The merger algorithm may optimize the reading conditions by choosing a low-sensitivity setup for pixels having a large or medium signal (according to a predetermined threshold), and leaving the high-sensitivity setup for pixels with signals too small to be correctly digitized, by the low-sensitivity setup. Once the algorithm is implemented, the high-sensitivity reading circuits allow sampling low-dose data, thus obtaining these data with a lower reading noise compared to noise introduced into measurement from using high-sensitivity reading circuits. Therefore, this algorithm reduces the overall reading noise due to judicious use of the inherently lower noise of the high-sensitivity mode.

In a further embodiment, the merger algorithm may provide an “initial guess” of a combined image to the post-processing algorithm. Then, if corrections are found to be required, the merger algorithm may provide the other gain of pixel/pixels.

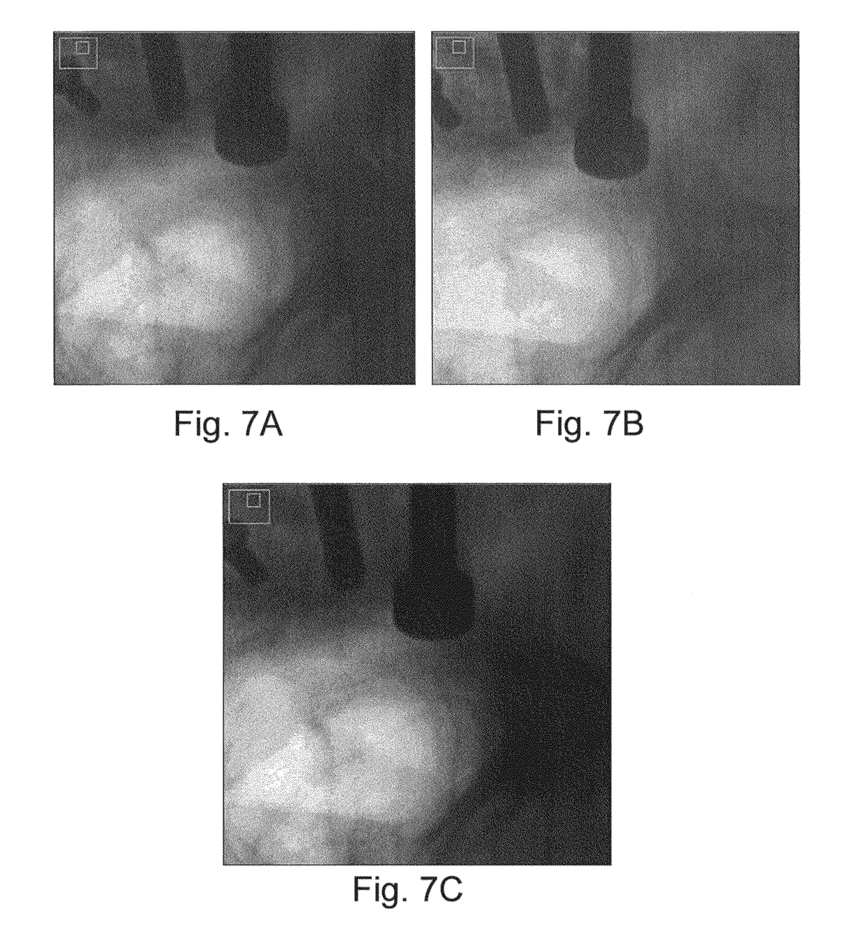

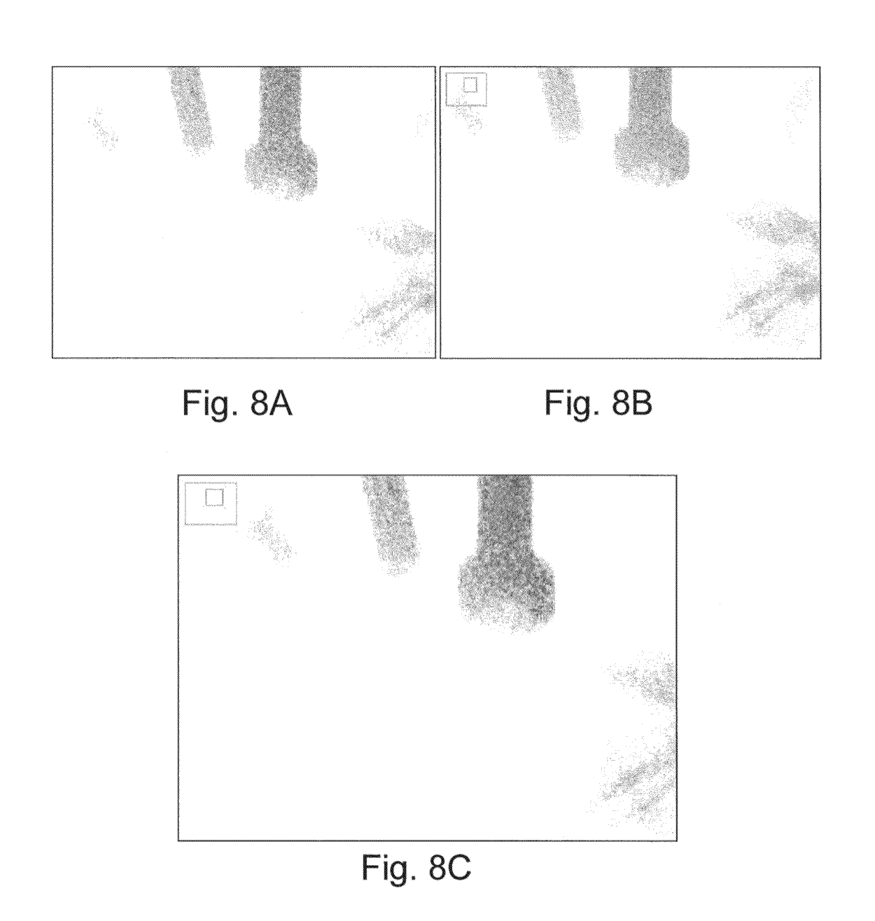

Referring now to FIGS. 7A-8C, these figures show exemplary outputs of the non-destructive reading method for a phantom image (i.e. not a living tissue) of skull and several screws. FIGS. 7A-7C are shown for a “soft tissue” windowing, and FIGS. 8A-8C are shown for a “metal” windowing.

FIG. 7A shows a low sensitivity image, FIG. 7B shows a high sensitivity image, and FIG. 7C shows a merged image. Similarly, FIG. 8A shows a low sensitivity image, FIG. 8B shows a high sensitivity image, and FIG. 8C shows a merged image.

The low sensitivity images (in FIGS. 7A and 8A) show the soft tissue better, while some details of the screws are lost. The merged images use the High Dynamic Range (HDR) technique to merge the low sensitivity and high sensitivity images, and thus take the advantages of both images. For example, soft tissue is shown with full details of the screws in the merged image (as in the high sensitivity image, in FIG. 7B) and thus no details of the screws are lost.

In a further embodiment, the non-destructive reading method allows selecting pixels not by values only (compared to common threshold methods) but also according to their “feature group” (e.g. implant). For example, the implant can be selected from the high sensitivity image only, although the low-sensitivity images are also detailed. Thus, a seamless image of the implant is obtained, without merger areas on the imaged object.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A detector for detecting radiation, comprising:
a scintillator layer configured to allow conversion of the radiation into optical signals;
an array of active pixel sensors (APS) positioned adjacent to the scintillator layer such that the optical signals are detected by the array of APS, and configured to allow conversion of the optical signals into electrical signals;
at least one internal temperature sensor coupled to at least one pixel of the array of APS, the at least one internal temperature sensor providing measurement of temperature;
at least two feedback circuits embedded into each pixel of the array;
processing electronics configured to allow sampling of said electrical signals by the at least two feedback circuits, and configured to allow corrections corresponding to the measured temperature such that a clean image is produced; and
an internal memory unit coupled to the array of APS, and configured to allow storage of correction parameters and of at least two images corresponding to the array of pixels, wherein the radiation detector is configured to acquire at least two images, corresponding to the at least two feedback circuits, and wherein the radiation detector outputs a single, merged image.

2. The detector of claim 1, wherein the at least two feedback circuits comprise:
a high-sensitivity reading circuit;
a low-sensitivity reading circuit; and
at least one switch configured to allow direction of electrical signals to at least one of the feedback circuit.

3. The detector of claim 1, wherein the at least one internal temperature sensor is movable such that a dynamic temperature scan is carried out.

4. A method for non-destructive radiation detection of an external object, the method comprising:
providing a scintillator layer configured to allow conversion of radiation into optical signals;
providing an array of active pixel sensors (APS) positioned adjacent to the scintillator layer, and configured to allow conversion of the optical signals into electrical signals;
providing at least two feedback circuits embedded into each pixel;
providing processing electronics coupled to each pixel;
performing a measurement of the object with external radiation;
sampling of the electrical signals from the array of APS with the processing electronics, for each of the at least two feedback circuits;
creating a full image corresponding to data from the pixels for each of the at least two feedback circuits;
performing a merger algorithm capable of combining data from the full images into a single image; and
outputting the single image.

5. The method of claim 4, further comprising:
providing an internal memory unit coupled to the APS array;
performing an air measurement, while no object is detected;
storing air parameters in the internal memory unit;
performing a dark current measurement, while no external radiation is detected:
storing dark current parameters in the internal memory unit;
calculating offset and gain values for each pixel of the array of APS, based on the stored dark current parameters and on the air parameters;
storing the offset and gain values in the internal memory unit; and
correcting data from each pixel of the array of APS according to the offset and gain values,
wherein the correction of the pixels produces a clean image.

6. The method of claim 4, further comprising storing the full images corresponding to the pixels of the array of APS in the internal memory unit.

7. The method of claim 4, further comprising:
selecting a group of pixels of the array of APS having a common feature from at least one of the full images corresponding to the at least two feedback circuits; and
introducing the selected group of pixels into the merged image.

8. The method of claim 4, further comprising:
providing a high-sensitivity reading circuit;
providing a low-sensitivity reading circuit;
providing at least one switch configured to allow direction of electrical signals to at least one of the feedback circuit;
reading high-sensitivity data with the high-sensitivity reading circuit;
storing the high-sensitivity data in a first database;
reading low-sensitivity data with the low-sensitivity reading circuit; and
storing the low-sensitivity data in a second database.

9. The method of claim 4, further comprising:
providing at least one internal temperature sensor coupled to at least one pixel of the array of APS;
providing an internal memory unit coupled to the APS array;
performing an air measurement, while no object is detected;
storing air parameters in the internal memory unit;
performing a dark current measurement, while no external radiation is detected;
storing dark current parameters in the internal memory unit;
calculating offset and gain values for each pixel of the array of APS, based on the stored dark current parameters on the air parameters, on the measured temperature and on the acquisition time; and
correcting scan data from each pixel according to the offset and gain values,
wherein the correction of the pixels produces a clean image.

10. A method for non-destructive radiation detection of an external object, the method comprising:
providing a scintillator layer configured to allow conversion of radiation into optical signals;
providing an array of active pixel sensors (APS) positioned adjacent to the scintillator layer, and configured to allow conversion of the optical signals into electrical signals;
providing at least one internal temperature sensor coupled to at least one pixel of the array of APS;
providing an internal memory unit coupled to the APS array;
providing processing electronics coupled to each pixel;
performing an air measurement, while no object is detected;
storing air parameters in the internal memory unit;
performing a dark current measurement, while no external radiation is detected;
storing dark current parameters in the internal memory unit;
performing a measurement of the external object with external radiation;
sampling of the electrical signals from the APS with the processing electronics;
calculating offset and gain values for each pixel of the array of APS, based on the stored dark current parameters, on the stored air parameters, on the measured temperature and on the acquisition time;
correcting data from each pixel according to the calculated offset and gain values;
creating a full image corresponding to the corrected data from the pixels of the array of APS; and
outputting the corrected full image.

11. The method of claim 10, further comprising storing the full image corresponding to the pixels of the array of APS, in the internal memory unit.

12. The method of claim 10, further comprising:
providing at least two feedback circuits embedded into each pixel;
creating a full image corresponding to data from the pixels of the array of APS for each of the at least two feedback circuits;
performing a merger algorithm capable of combining data from the full images into a single image; and
outputting the corrected single image.

13. The method of claim 10, further comprising:
providing at least two feedback circuits embedded into each pixel;
creating a full image corresponding to data from the pixels of the array of APS for each of the at least two feedback circuits;
performing a merger algorithm capable of combining data from the full images into a single image;
selecting a group of pixels of the array of APS having a common feature from at least one of the full images corresponding to the at least two feedback circuits;
introducing the selected group of pixels into the single image; and
outputting the corrected single image.

14. The method of claim 10, further comprising:
providing at least two feedback circuits embedded into each pixel, wherein at least one feedback circuit comprises a high-sensitivity reading circuit and at least one feedback circuit comprises a low-sensitivity reading circuit;
providing at least one switch configured to allow direction of electrical signals to at least one of the feedback circuit;
reading high-sensitivity data with the high-sensitivity reading circuit;
storing the high-sensitivity data in a first database;
reading low-sensitivity data with the low-sensitivity reading circuit;
storing the low-sensitivity data in a second database;
performing a merger algorithm capable of combining data from the full images into a single image; and
outputting the corrected single image,
wherein a full image is created for the high-sensitivity reading circuit and for the low-sensitivity reading circuit.
